(19) United States
(12) Patent Application Publication
(10) Pub. No.: US 2010/0199000 A1
(43) Pub. Date: Aug. 5, 2010

(54) DATA STORAGE DEVICE AND METHOD FOR OPERATING THE SAME

(75) Inventors: Hung-Yi Huang, Taoyuan County (TW); Chih-Ling Chien, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HTC Corporation, Taoyuan County (TW)

(21) Appl. No.: 12/421,648

(22) Filed: Apr. 10, 2009

(30) Foreign Application Priority Data
Feb. 5, 2009 (TW) 98103669

(51) Int. Cl. G06F 13/00

(52) U.S. Cl. 710/33

(57) ABSTRACT

A data storage device including a main body and a storage element is provided. The main body has a first connecting part and a second connecting part, suitable for being connected to a first electronic device and a second electronic device, respectively. The storage element is disposed at the main body and is electrically connected to the first connecting part and the second connecting part, wherein the data storage device is suitable for receiving data from the first electronic device, and the data is stored in the storage element, or is transmitted to the second electronic device, or the data is stored in the storage element and is transmitted to the second electronic device. In addition, an operating method of the data storage device is also provided.

### CROSS-REFERENCE TO RELATED APPLICATION

This application claims the priority benefit of Taiwan application serial No. 98103669, filed on Feb. 5, 2009. The entirety of the above-mentioned patent application is hereby incorporated by reference herein and made a part of this specification.

### BACKGROUND OF THE INVENTION

1. Field of the Invention

The present application relates to a data storage device and a method for operating the same. More particularly, the present application relates to a data storage device having a data transmission function and a data storage function, and a method for operating the same.

2. Description of Related Art

With development of information technology, storage media manufactured by semiconductor technique gradually become mainstream products, which are generally referred to as potable memories, flash memory cards or memory cards. Compared to the conventional storage media such as a soft disk and a compact disk, characteristics such as easy carry, power saving, data storage, data transmission rate, re-readable/re-writable, shockproof, damp proof, etc. of the memory card are far more better than that of the conventional storage media. Since the memory card has such superior characteristics, various electronic product manufacturers of different nations actively enter this market and develop their lead memory cards such as smart cards, PCMCIA ATA flash cards (PC cards), compact flash cards (CF cards), smart media cards (SM cards), multimedia cards (MMC cards), memory stick cards (MS cards) and secure digital cards (SD cards), etc. for applying to various digital products.

When a user needs to transmit data stored in each of the aforementioned various memory cards to a personal computer, a transmission cable is generally applied for the data transmission. If the transmission cable is not applied, the data transmission between the memory card and the personal computer then cannot be performed.

### SUMMARY OF THE INVENTION

The present application is directed to a data storage device, which can be connected between two electronic devices for data storage and data transmission.

The present application is directed to a method for operating a data storage device, by which the data storage device connected between two electronic devices can be operated for data storage and data transmission.

The present application provides a data storage device comprising a main body and a storage element. The main body has a first connecting part and a second connecting part, suitable for being connected to a first electronic device and a second electronic device, respectively. The storage element is disposed at the main body and is electrically connected to the first connecting part and the second connecting part, wherein the data storage device is suitable for receiving data from the first electronic device, and the data is selected for being stored in the storage element, being transmitted to the second electronic device, or being both stored in the storage element and transmitted to the second electronic device.

The present application provides a method for operating a data storage device comprising a storage element. First, data is transmitted from a first electronic device to the data storage device. Next, the data is stored into the storage device, or is transmitted from the data storage device to a second electronic device, or the data is stored into the storage element and is transmitted from the data storage device to the second electronic device.

Accordingly, the data storage device of the present application can be connected between the first electronic device and the second electronic device through the first connecting part and the second connecting part, so as to transmit data from the first electronic device to the second electronic device, store the data from the first electronic device into the storage element of the data storage device, or both transmit the data from the first electronic device to the second electronic device and store the data from the first electronic device into the storage element of the data storage device.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional diagram of a data storage device according to an embodiment of the present invention.

FIG. 2 is a block diagram illustrating a data storage device of FIG. 1.

FIG. 3 is a three-dimensional diagram of a data storage device according to another embodiment of the present invention.

### DESCRIPTION OF EMBODIMENTS

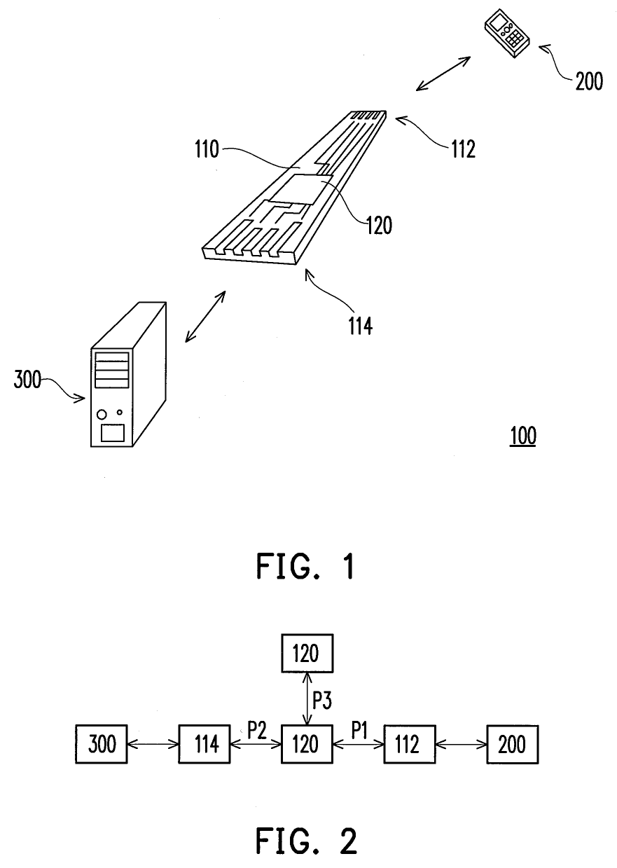

FIG. 1 is a three-dimensional diagram of a data storage device according to an embodiment of the present invention. Referring to FIG. 1, the data storage device 100 includes a main body 110 and a storage element 120. The main body 110 has a first connecting part 112 and a second connecting part 114 for respectively connecting a first electronic device 200 and a second electronic device 300. In the present embodiment, the first electronic device 200 and the second electronic device 300 are, for example, a mobile phone and a host of a personal computer or a laptop computer, respectively.

The storage element 120 is disposed at the main body 110, and is electrically connected to the first connecting part 112 and the second connecting part 114, wherein the data storage device 100 is suitable for receiving data from the first electronic device 200, and the data is selected for being stored into the storage element 120, being transmitted to the second electronic device 300, or being both stored into the storage element 120 and transmitted to the second electronic device 300.

In detail, the data storage device 100 can be connected to the first electronic device 200 or the second electronic device 300 for receiving data from the first electronic device 200 or the second electronic device 300. Moreover, the data storage device 100 can further be simultaneously connected to the first electronic device 200 and the second electronic device 300 for transmitting data from the first electronic device 200 to the second electronic device 300, or transmitting data from the second electronic device 300 to the first electronic device 200. Particularly, during the data transmission process, the data storage device 100 can simultaneously store data received form the first electronic device 200 or the second electronic device 300 to the storage element 120. In other words, the data storage device 100 has both a data transmission function and a data storage function, and can simultaneously perform the data transmission and the data storage operations, so that utilization thereof is more convenient and flexible.

The first connecting part 112 and the second connecting part 114 can be connecting terminals in different specifications. In the present embodiment, the first connecting part 112 and the second connecting part 114 are, for example, two of a universal serial bus (USB) interface, a mini universal serial buss (Mini-USB) interface and a micro universal serial buss (Micro-USB) interface, and are respectively used for connecting the first electronic device (the host of the personal computer or the laptop computer) 200 and the second electronic device (the mobile phone) 300.

FIG. 2 is a block diagram illustrating the data storage device of FIG. 1. Referring to FIG. 2, in the present embodiment, the data storage device 100 further includes a control device 130 disposed at the main body 110 (shown in FIG. 1), and electrically connected among the first connecting part 112, the second connecting part 114 and the storage element 120. The control device 130 controls to store the data into the storage element 120, or transmit the data from the first electronic device 200 to the second electronic device 300 (or from the second electronic device 300 to the first electronic device 200), or to store the data into the storage element 120 and transmit it from the first electronic device 200 to the second electronic device 300 (or from the second electronic device 300 to the first electronic device 200).

For example, if the user only wants to store the data into the storage element 120, when the data is transmitted from the first connecting part 112 to the control device 130 through a transmission path P1, the user controls the control device 130 to store the data into the storage element 120 through a transmission path P3, and block a transmission path P2. If the user only wants to use the data transmission function of the data storage device 100, when the data is transmitted from the first connecting part 112 to the control device 130 through the transmission path P1, the user controls the control device 130 to transmit the data to the second connecting part 114 through the transmission path P2, and further transmit the data to the second electronic device 300, and block the transmission path P3. The user can control operations of the control device 130 through a switch (not shown) on the main body 110 of the data storage device 100. Moreover, the user can also control the operations of the control device 130 through an operation interface of the first electronic device 200 or the second electronic device 300.

It should be noted that the aforementioned data transmission direction is only used for an example, and the data transmission direction is not limited by the present invention. The data can be transmitted from the first electronic device 200 to the second electronic device 300 sequentially through the first connecting part 112, the transmission path P1, the control device 130, the transmission path P2 and the second connecting part 114, or can be transmitted from the first electronic device 200 to the storage element 120 sequentially through the first connecting part 112, the transmission path P1, the control device 130 and the transmission path P3, or can be transmitted from the second electronic device 300 to the first electronic device 200 sequentially through the second connecting part 114, the transmission path P2, the control device 130, the transmission path P1 and the first connecting part 112, or can be transmitted from the second electronic device 300 to the storage element 120 sequentially through the second connecting part 114, the transmission path P2, the control device 130 and the transmission path P3.

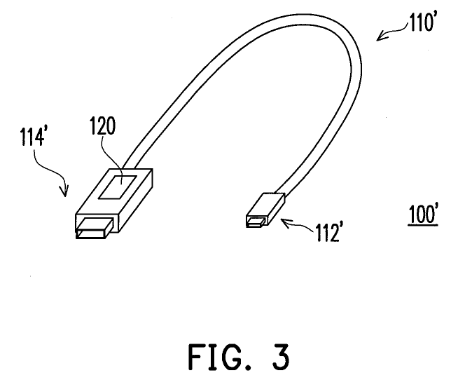

Referring to FIG. 1, in the present embodiment, the main body 110 is, for example, a flat stick, and the first connecting part 112 and the second connecting part 114 are respectively a plurality of finger-shaped contacts disposed at two opposite ends of the flat stick. Moreover, the storage element 130 is, for example, a memory chip embedded in the main body 110. However, a shape of the main body 110 is not limited by the present application. FIG. 3 is a three-dimensional diagram of a data storage device according to another embodiment of the present invention. Referring to FIG. 3, in the present embodiment, the main body 110′ is a transmission cable, and the first connecting part 112′ and the second connecting part 114′ are respectively two jacks disposed at two opposite ends of the transmission cable.

In summary, the data storage device of the present invention can be connected between the first electronic device and the second electronic device through the first connecting part and the second connecting part, so that the at least one of the functions including transmitting data between the first electronic device and the second electronic device, and storing data from the first electronic device or the second electronic device can be selectively performed. Moreover, the data storage device further includes a control device, so that the user can switch the control device to perform the aforementioned various data transmission or data storage functions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data storage device, comprising:
a main body, having a first connecting part and a second connecting part, for being connected to a first electronic device and a second electronic device, respectively; and
a storage element, disposed at the main body, and electrically connected to the first connecting part and the second connecting part, wherein the data storage device receives data from the first electronic device, and the data is selected for being stored in the storage element, being transmitted to the second electronic device, or being both stored in the storage element and transmitted to the second electronic device.

2. The data storage device as claimed in claim 1, the first connecting part and the second connecting part are connecting terminals in different specifications.

3. The data storage device as claimed in claim 1, further comprising a control device disposed at the main body and electrically connected among the first connecting part, the second connecting part and the storage element, wherein the control device controls to store the data into the storage element, or transmit the data to the second electronic device, or to store the data into the storage element and transmit the data to the second electronic device.

4. The data storage device as claimed in claim 1, wherein the main body comprises a flat stick, and the first connecting part and the second connecting part are respectively a plurality of finger-shaped contacts disposed at two opposite ends of the flat stick.

5. The data storage device as claimed in claim 1, wherein the main body is a transmission cable, and the first connecting part and the second connecting part are respectively two jacks disposed at two opposite ends of the transmission cable.

6. The data storage device as claimed in claim 1, wherein the storage element is a memory chip embedded in the main body.

7. A method for operating a data storage device comprising a storage element, the method comprising:
transmitting data from a first electronic device to the data storage device; and
selecting to store the data into the storage device, or transmit the data from the data storage device to a second electronic device, or to store the data into the storage element and transmit the data from the data storage device to the second electronic device.

8. The method for operating a data storage device as claimed in claim 7, wherein the data storage device further comprises a control device, and the control device controls to store the data into the storage element, or transmit the data to the second electronic device, or to store the data into the storage element and transmit the data to the second electronic device.
